(19) United States
(12) Patent Application Publication
(10) Pub. No.: US 2026/0048573 A1
(43) Pub. Date: Feb. 19, 2026

(54) METALLIZED GLASS SUBSTRATE AND METHOD FOR MANUFACTURING THE SAME

(71) Applicants: National Tsing Hua University, HSINCHU CITY (TW); UNIMICRON TECHNOLOGY CORP., TAOYUAN HSIEN (TW)

(72) Inventor: TZU-CHIEN WEI, HSINCHU CITY (TW)

(21) Appl. No.: 19/014,332

(22) Filed: Jan. 9, 2025

(30) Foreign Application Priority Data
Aug. 13, 2024 (TW) 113130235

(51) Int. Cl. B32B 17/06

(52) U.S. Cl. CPC B32B 17/061; B32B 2250/03; B32B 2264/105; B32B 2264/301; B32B 2305/026; B32B 2307/538; B32B 2307/7376; B32B 2311/18

(57) ABSTRACT

A metallized glass substrate includes a glass substrate, a heterogeneous bonding layer, and a metal layer. The heterogeneous bonding layer is disposed on the glass substrate. The heterogeneous bonding layer includes a porous structure and a metal catalyst. The porous structure is formed on the glass substrate. A thickness of the porous structure ranges from 210 nm to 350 nm. The metal catalyst is adhered to the porous structure. A microstructure of the heterogeneous bonding layer includes Si—O—Ti bonds. The metal layer is disposed on the heterogeneous bonding layer.

### CROSS-REFERENCE TO RELATED PATENT APPLICATION

This application claims the benefit of priority to Taiwan Patent Application No. 113130235, filed on Aug. 13, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a metallized glass substrate and a method for manufacturing the same, and more particularly to a metallized glass substrate with high peel strength and a method for manufacturing the same.

### BACKGROUND OF THE DISCLOSURE

In response to the development of 5th generation wireless system (5G), the industry is currently committed to reducing the signal loss of substrates under high-frequency and high-speed transmission conditions.

To reduce signal loss, glass is a material with great potential and can be used as printed circuit board materials and 3D packaging materials. The disadvantage is that glass is not easily bonded to other metal materials. Glass has a very smooth surface and has a high chemical passivity. Even after a metal layer is formed on the glass, the peel strength of the metal layer is not high. Specifically, the peel strength of currently commercially available metallized glass substrates is approximately 150 gf/cm. Therefore, how to improve the adhesion of the metal layer on the glass substrate through material improvement has become an important issue yet to be solved in this field.

### SUMMARY OF THE DISCLOSURE

In response to the above-referenced technical inadequacy, the present disclosure provides a metallized glass substrate and a method for manufacturing the same.

In order to solve the above-mentioned problems, one of the technical aspects adopted by the present disclosure is to provide a metallized glass substrate. The present disclosure discloses a metallized glass substrate and a method for manufacturing the same. The metallized glass substrate includes a glass substrate, a heterogeneous bonding layer and a metal layer. The heterogeneous bonding layer is disposed on the glass substrate. The heterogeneous bonding layer includes a porous structure and a metal catalyst. The porous structure is formed on the glass substrate. A thickness of the porous structure ranges from 210 nm to 350 nm. The metal catalyst is adhered to the porous structure. A microstructure of the heterogeneous bonding layer includes Si—O—Ti bonds. The metal layer is disposed on the heterogeneous bonding layer.

In one of the possible or preferred embodiments, an atomic ratio of the Si—O—Ti bonds in the heterogeneous bonding layer ranges from 20% to 40%.

In one of the possible or preferred embodiments, the microstructure of the heterogeneous bonding layer includes the Si—O—Ti bonds with the atomic ratio ranging from 25% to 35%, Si—O—Si bonds with an atomic ratio ranging from 40% to 50%, Ti—O—Ti bonds with an atomic ratio ranging from 15% to 20%, and C—O bonds with an atomic ratio ranging from 5% to 15%.

In one of the possible or preferred embodiments, a surface roughness (Sa) of the heterogeneous bonding layer ranges from 15 nm to 25 nm.

In one of the possible or preferred embodiments, an average pore size of the porous structure ranges from 10 nm to 40 nm.

In one of the possible or preferred embodiments, a material of the porous structure includes titanium dioxide.

In one of the possible or preferred embodiments, a surface density of the metal catalyst of the heterogeneous bonding layer ranges from 80 mg/cm² to 110 mg/cm².

In one of the possible or preferred embodiments, a particle size of the metal catalyst ranges from 2 nm to 10 nm.

In one of the possible or preferred embodiments, the metal catalyst adheres to the porous structure through a protective structure.

In one of the possible or preferred embodiments, the protective structure is formed from silane with a molecular weight of 150 g/mol to 300 g/mol.

In one of the possible or preferred embodiments, the protective structure is (3-aminopropyl)triethoxysilane.

In one of the possible or preferred embodiments, the metal layer is partially embedded in the heterogeneous bonding layer.

In order to solve the above-mentioned problems, another one of the technical aspects adopted by the present disclosure is to provide a metallized glass substrate. The metallized glass substrate includes a glass substrate, a heterogeneous bonding layer and a metal layer. The heterogeneous bonding layer is disposed on the glass substrate. The heterogeneous bonding layer includes a porous structure and a metal catalyst. The porous structure is formed on the glass substrate. A material of the porous structure includes titanium dioxide, and a thickness of the porous structure ranges from 210 nm to 350 nm. The metal catalyst is adhered to the porous structure, and the metal layer is partially embedded in the heterogeneous bonding layer.

In one of the possible or preferred embodiments, a microstructure of the heterogeneous bonding layer includes Si—O—Ti bonds.

In one of the possible or preferred embodiments, an atomic ratio of the Si—O—Ti bonds in the heterogeneous bonding layer ranges from 20% to 40%.

In one of the possible or preferred embodiments, the microstructure of the heterogeneous bonding layer includes the Si—O—Ti bonds with the atomic ratio ranging from 25% to 35%, Si—O—Si bonds with an atomic ratio ranging from 40% to 50%, Ti—O—Ti bonds with an atomic ratio ranging from 15% to 20%, and C—O bonds with an atomic ratio ranging from 5% to 15%.

In one of the possible or preferred embodiments, a surface roughness (Sa) of the heterogeneous bonding layer ranges from 15 nm to 25 nm.

In one of the possible or preferred embodiments, an average pore size of the porous structure ranges from 10 nm to 40 nm.

In one of the possible or preferred embodiments, a surface density of the metal catalyst of the heterogeneous bonding layer ranges from 80 mg/cm² to 110 mg/cm².

In one of the possible or preferred embodiments, a particle size of the metal catalyst ranges from 2 nm to 10 nm.

In one of the possible or preferred embodiments, the metal catalyst adheres to the porous structure through a protective structure.

In one of the possible or preferred embodiments, the protective structure is formed from silane with a molecular weight of 150 g/mol to 300 g/mol.

In one of the possible or preferred embodiments, the protective structure is (3-aminopropyl)triethoxysilane.

In order to solve the above-mentioned problems, yet another one of the technical aspects adopted by the present disclosure is to provide a method for manufacturing a metallized glass substrate, including: forming a porous structure on a glass substrate; performing an activation process, so as to make a metal catalyst adhere to the porous structure to form a heterogeneous bonding layer; and performing a metallization process, so as to form a metal layer on the heterogeneous bonding layer. A thickness of the porous structure ranges from 210 nm to 350 nm. A microstructure of the heterogeneous bonding layer includes Si—O—Ti bonds.

In one of the possible or preferred embodiments, the process of forming the porous structure further includes: applying a slurry mixture on the glass substrate, and the slurry mixture includes a titanium ion-containing compound and a titanium-containing metal compound; and performing a sintering process, so that the titanium ion-containing compound and the titanium-containing metal compound form the porous structure.

In one of the possible or preferred embodiments, the process of forming the porous structure further includes: applying a precursor solution on the glass substrate, and the precursor solution includes a titanium ion-containing compound; applying a slurry mixture on the glass substrate, and the slurry mixture includes a titanium-containing metal compound; and performing a sintering process, so that the titanium ion-containing compound and the titanium-containing metal compound form the porous structure.

In one of the possible or preferred embodiments, a weight ratio of the titanium ion-containing compound to the titanium-containing metal compound ranges from 6:1 to 8:1.

In one of the possible or preferred embodiments, the titanium ion-containing compound includes titanium diisopropoxybisacetylacetonate.

In one of the possible or preferred embodiments, the titanium-containing metal compound includes titanium dioxide with a size ranging from 20 nm to 30 nm.

In one of the possible or preferred embodiments, the process of the activation process further includes: preparing a metal catalyst solution, and the metal catalyst solution includes the metal catalyst; and immersing the porous structure in the metal catalyst solution, so that the metal catalyst adheres to the porous structure.

In one of the possible or preferred embodiments, a content of the metal catalyst in the metal catalyst solution ranges from 140 ppm to 160 ppm.

In one of the possible or preferred embodiments, the metal catalyst solution further includes a protective agent, so that the metal catalyst adheres to the porous structure through the protective agent, and the protective agent is silane with a molecular weight ranging from 150 g/mol to 300 g/mol.

In one of the possible or preferred embodiments, the metal catalyst solution is formed by mixing a metal ion compound, a protective agent and an alcoholic solvent, and then adding a reducing agent, and the metal ion compound is reduced by the reducing agent to produce the metal catalyst.

In one of the possible or preferred embodiments, the metal ion compound includes palladium chloride.

Therefore, in the metallized glass substrate and the method for manufacturing the same provided by the present disclosure, by virtue of “the microstructure of the heterogeneous bonding layer including Si—O—Ti bonds,” or “the material of the porous structure including titanium dioxide, and the thickness of the porous structure ranging from 210 nm to 350 nm,” the adhesion of the metal layer to the glass substrate can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic cross-sectional view of a metallized glass substrate of the present disclosure;

FIG. 2 is a schematic enlarged view of part II of FIG. 1;

FIG. 3 to FIG. 6 are schematic views of steps of a method for manufacturing a metallized glass substrate of the present disclosure;

FIG. 7 is a scanning electron microscope image of a porous structure of the present disclosure;

FIG. 8 is a scanning electron microscope image of a heterogeneous adhesive layer of the present disclosure; and

FIG. 9 is a result diagram of the heterogeneous bonding layer of the present disclosure analyzed by an X-ray photoelectron spectrometer.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

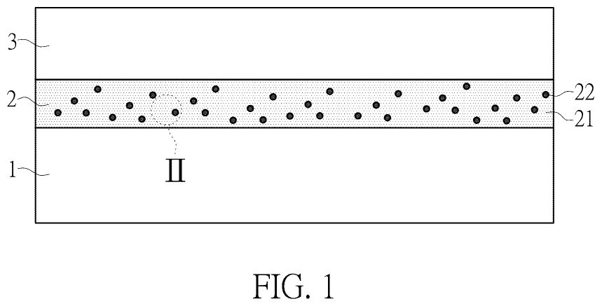

In order to improve the adhesion of a metal layer on a glass substrate, the present disclosure forms a heterogeneous bonding layer on the glass substrate. Referring to FIG. 1, A metallized glass substrate of the present disclosure includes a glass substrate 1, a heterogeneous bonding layer 2 and a metal layer 3. The heterogeneous bonding layer 2 is disposed between the glass substrate 1 and the metal layer 3.

Through the arrangement of the heterogeneous bonding layer, the metallized glass substrate of the present disclosure has good peel strength (which is from 1,100 gf/cm to 1,500 gf/cm), and the quality of each batch of products is uniform (the standard deviation of peel strength is less than 100 gf/cm). Even if the metallized glass substrate is reflowed five times at high temperature (250° C.), it can still have a peel strength greater than 1,000 gf/cm. Specific measurement results will be described hereafter.

The heterogeneous bonding layer 2 includes a porous structure 21 and a metal catalyst 22, and the metal catalyst 22 adheres to the porous structure 21. The porous structure 21 can assist the dispersion of the metal catalyst 22, serve as a carrier for the metal catalyst 22 to adhere, and can also improve the bonding force between the metal layer 3 and the glass substrate 1.

The material of the porous structure 21 includes titanium dioxide. Specifically, an average pore size of the porous structure 21 ranges from 10 nm to 40 nm, preferably from 15 nm to 35 nm, e.g., a positive integer between 10 nm and 40 nm. During the formation of the metal layer 3, the metal layer 3 can partially be embedded in the porous structure 21, thereby improving the bonding force of the metal layer 3 on the glass substrate 1.

A thickness of the porous structure 21 preferably ranges from 210 nm to 350 nm, e.g., a positive integer between 210 nm and 350 nm. When the thickness of the porous structure 21 is too thin, the bonding force between the glass substrate 1 and the metal layer 3 cannot be effectively improved. When the thickness of the porous structure 21 is too thick, it is difficult to release the stress and the bonding force may decrease.

The metal catalyst 22 can be used as a catalyst during the subsequent electroless plating process to facilitate the formation of the metal layer 3. The metal catalyst 22 can be palladium metal with a particle size ranging from 2 nm to 10 nm. For instance, a positive integer between 2 nm and 10 nm. Therefore, under the same size specifications, the heterogeneous bonding layers 2 with high uniformity and similar characteristics can be formed, so that the finally produced metallized glass substrate can have better reliability.

On the other hand, after the porous structure 21 is adhered by the metal catalyst 22, the heterogeneous bonding layer 2 can have a rougher surface, which is more conducive to improving the adhesion effect of the metal layer 3. Specifically, the surface roughness (arithmetic mean height, Sa) of the heterogeneous bonding layer 2 ranges from 15 nm to 25 nm, e.g., a positive integer between 15 nm and 25 nm.

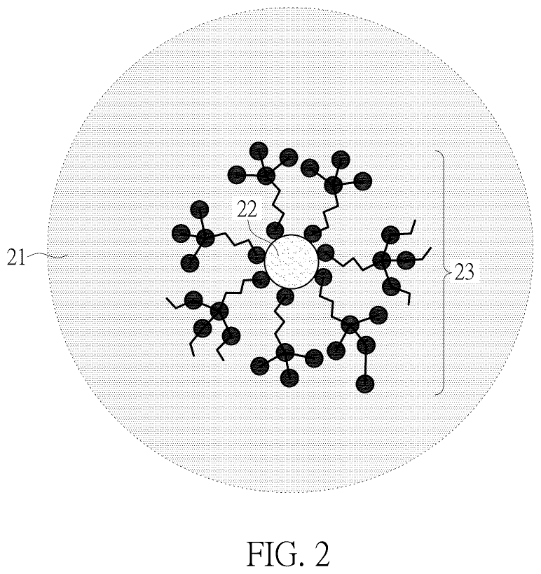

Referring to FIG. 2, the metal catalyst 22 is surrounded by a protective structure 23, and the metal catalyst 22 can adhere to the porous structure 21 through the protective structure 23. The formation of the protective structure 23 can protect and disperse the metal catalyst 22, thereby improving the stability of the metal catalyst 22 in the porous structure 21.

The protective structure 23 can be formed by self-assembly of silane. The hydrophilic end of the silane is connected to the metal catalyst 22, and the hydrophobic end of the silane is connected to the porous structure 21 and is bonded with the porous structure 21. Specifically, the molecular weight of the silane can range from 150 g/mol to 300 g/mol, preferably silane with an amino group at the end, such as but not limited to (3-aminopropyl)triethoxysilane (APTES).

The formation of the protective structure 23 can improve the dispersion and stability of the metal catalyst 22 in the porous structure 21, so that the subsequent catalyzing of the formation of the metal layer 3 can be achieved by using less of the metal catalyst 22.

Specifically, a surface density of the metal catalyst 22 of the present disclosure of the heterogeneous bonding layer 2 is relatively low. The surface density of the metal catalyst 22 of the heterogeneous bonding layer 2 ranges from 80 mg/dm² to 110 mg/dm², e.g., a positive integer between 80 mg/dm² and 110 mg/dm².

In comparison, if the metal catalyst 22 (without forming the protective structure 23) directly adheres to the porous structure 21, the surface density of the metal catalyst 22 of the heterogeneous bonding layer 2 needs to be higher than 110 mg/dm² to achieve the effect of subsequent catalytic formation of the metal layer 3.

When the metal catalyst 22 adheres to the porous structure 21 through the protective structure 23, the microstructure of the heterogeneous bonding layer 2 will have silicon-oxygen-titanium (Si—O—Ti) bonds. After measurement by X-ray photoelectron spectroscopy (XPS), the atomic ratio of Si—O—Ti bonds in the microstructure of the heterogeneous bonding layer 2 ranges from 20% to 40%. For instance, a content of Si—O—Ti bonds can be a positive integer between 20% and 40%.

In addition to Si—O—Ti bonds, the microstructure of the heterogeneous bonding layer 2 can also include silicon-oxygen-silicon (Si—O—Si) bonds, titanium-oxygen-titanium (Ti—O—Ti) bonds, and carbon-oxygen (C—O) bonds. From the perspective of atomic ratio, the content of Si—O—Si bonds is higher than that of Ti—O—Ti bonds, and the content of Ti—O—Ti bonds is higher than that of C—O bonds.

Specifically, in addition to the Si—O—Ti bonds, the microstructure of the heterogeneous bonding layer 2 can further include the Si—O—Si bonds with the atomic ratio ranging from 40% to 50%, and the Ti—O—Ti bonds with the atomic ratio ranging from 15% to 20%, and the C—O bonds with the atomic ratio ranging from 5% to 15%.

A method for manufacturing the metallized glass substrate of the present disclosure includes the following steps: performing a cleaning process (step S1); applying a precursor solution L1 (step S2); applying a slurry mixture L2 (step S3); performing a sintering process to form the porous structure 21 (step S4); performing a preparation process (step S5); performing an activation process to form the heterogeneous bonding layer 2 (step S6); perform a metallization process to form the metal layer 3 (step S7); and perform an annealing process (step S8).

In the cleaning process of step S1, the RCA cleaning process can be used to remove dust or impurities on the surface of the glass substrate 1, so that hydroxyl groups (—OH) are formed on the surface of the glass substrate 1. After the hydroxyl groups are formed, it is more conducive to the subsequent formation of the heterogeneous bonding layer 2. It should be supplemented that the way used in the cleaning process is not limited to the RCA cleaning process and can also be other processes for cleaning the surface of the glass substrate 1, or processes for forming hydroxyl groups on the glass surface.

Referring to FIG. 3, in step S2, the precursor solution L1 is applied on the glass substrate 1 after being cleaned by spin coating (rotation speed is from 5000 to 7000 per minute), but the application method of the precursor solution L1 is not limited thereto. The application of the precursor solution L1 helps to improve the bonding force of the porous structure 21 on the glass substrate 1 and stabilizes the structural stability of the porous structure 21.

The precursor solution L1 includes a titanium ion-containing compound with a concentration of 0.10 M to 0.20 M and an alcohol solvent. Specifically, the titanium ion-containing compound can be titanium diisopropoxide bis(acetylacetonate) (TTDB), and the alcohol solvent can be isopropyl alcohol.

In order to prevent the titanium dioxide applied in step S3 from being dissolved in the solvent again, after applying the precursor solution L1 (step S2), the glass substrate 1 can be baked at a temperature of 110° C. to 130° C. for 10 minutes to remove the solvent.

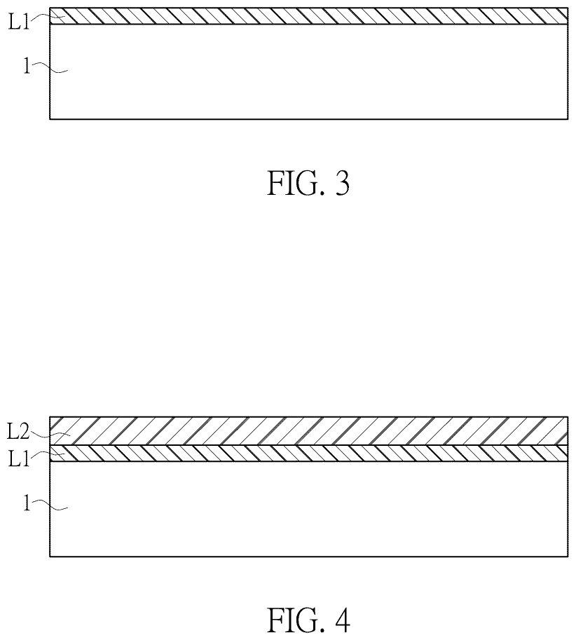

Referring to FIG. 4, in step S3, the slurry mixture L2 is applied on the glass substrate 1 after being baked by spin coating (rotation speed is from 5000 to 7000 per minute). The amount of slurry mixture L2 applied is positively correlated with the thickness of the porous structure 2 at final.

The slurry mixture L2 includes a titanium-containing metal compound, and can further include another titanium ion-containing compound. That is to say, the slurry mixture L2 can include only the titanium-containing metal compound, or both the titanium-containing metal compound and the titanium ion-containing compound. It should be supplemented that the titanium ion-containing compound in the precursor solution L1 and the another titanium ion-containing compound in the slurry mixture L2 can be the same or different.

Specifically, the titanium-containing metal compound can be titanium dioxide with a size ranging from 20 nm to 30 nm, and the titanium ion-containing compound can be titanium diisopropoxybisacetylacetonate. In addition, when the slurry mixture includes both the titanium ion-containing compound and the titanium-containing metal compound, a weight ratio of the titanium ion-containing compound to the titanium-containing metal compound ranges from 6:1 to 8:1.

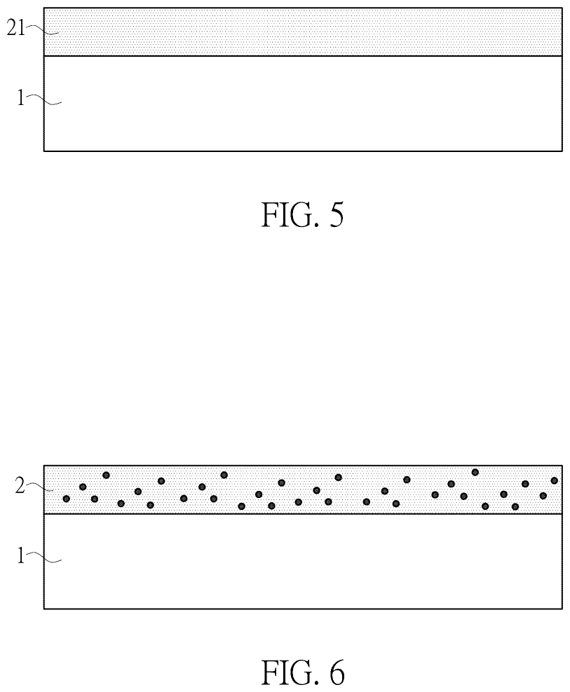

In step S4, the glass substrate 1 after being sequentially coated with the precursor solution L1 and the slurry mixture L2 is sintered at a temperature of 325° C. to 600° C. to form the porous structure 21 on the surface of the glass substrate 1, as shown in FIG. 5. In an exemplary embodiment, the glass substrate 1 is sequentially placed at four temperatures between 325° C. and 600° C. for continuous heating and sintering from low to high, but the present disclosure is not limited thereto.

The present disclosure sets titanium atoms in both an ionic state and a metallic state on the glass substrate 1 through steps S2 (applying precursor solution L1) and S3 (applying slurry mixture L2), respectively. After sintering, the porous structure 21 can have an ideal microstructure, which can help improve the peeling strength of the metal layer 3 on the glass substrate 1.

In step S5, a metal ion compound, a protective agent, and an alcohol solvent are uniformly mixed, and then a reducing agent is added to obtain a metal catalyst solution. The addition of the reducing agent can reduce the metal ions in the metal ion compound to the metal catalyst 22 which is aforementioned. Since the protective agent is self-assembled around the metal catalyst 22 (to form a protective structure 23), the metal catalyst 22 can be prevented from gathering and settling. Specifically, the metal ion compound can be palladium chloride.

In step S6, the glass substrate 1 is immersed in the metal catalyst solution so that the metal catalyst 22 in the metal catalyst solution adheres to the porous structure 21. More specifically, the metal catalyst 22 adheres to the porous structure 21 through the protective structure 23 around it, forming the heterogeneous bonding layer 2, as shown in FIG. 6. Specifically, the concentration of the metal catalyst 22 in the metal catalyst solution ranges from 100 ppm to 200 ppm.

In step S7, the metal layer 3 can be formed on the heterogeneous bonding layer 2 through an electroless plating process. Since the metal catalyst 22 adheres to the porous structure 21, the metal layer 3 is embedded in the porous structure 21 of the heterogeneous bonding layer 2. In addition, in order to increase the thickness of the metal layer 3, an electroplating process can be selectively performed, but the present disclosure is not limited thereto.

In step S8, an annealing process is performed at a temperature of 450° C. to 550° C. to rearrange the atoms of the metal layer 3 to obtain better peel strength. In this way, the metallized glass substrate 1 shown in FIG. 1 of the present disclosure can be obtained.

For the convenience of describing the present disclosure, Embodiment 1 is used to describe in detail the specific steps of implementing the present disclosure, but the present disclosure is not limited thereto.

### Embodiment 1

Remove dust or impurities on the surface of the glass substrate (soda-lime glass) by the RCA cleaning process.

Next, a precursor solution and a slurry mixture are prepared. The precursor solution is an isopropyl alcohol (alcohol solvent) solution containing titanium diisopropoxy diacetyl acetonate (TTDB) (titanium ion-containing compound) with a concentration of 0.15M. The slurry mixture is a mixture of the precursor solution and commercial titanium dioxide slurry (model: 30 NR-D Titania Paste) in a weight ratio of 7:1. The main component of titanium dioxide slurry includes titanium dioxide (titanium-containing metal compound) dispersed therein.

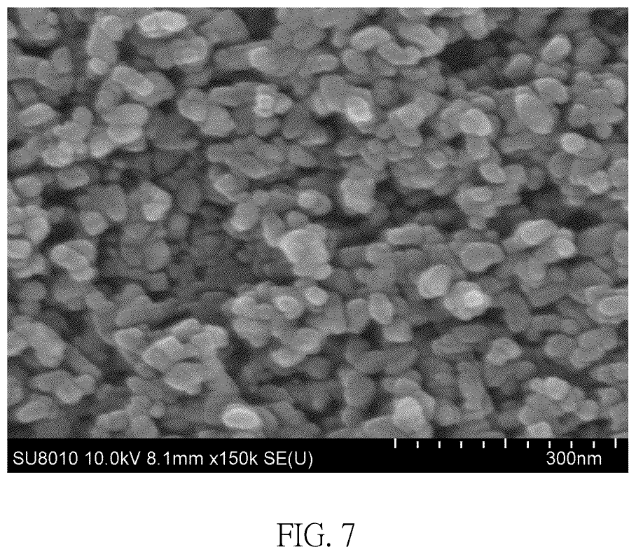

After coating the precursor solution on the glass substrate at a rotation speed of 6,000 rpm, place it on a hot plate at 120° C. to evaporate the solvent. The slurry mixture is then coated on the glass substrate at a rotation speed of 6,000 rpm and sintered at 600° C. to form a porous structure with a thickness of 330 nm. The scanning electron microscope image of the porous structure is shown in FIG. 7, the average pore size of the porous structure is 30 nm.

Before preparing a metal catalyst solution, a protective agent solution, a palladium ion solution and a reducing agent solution are first prepared. The protective agent solution is formed by mixing 3 ml of (3-aminopropyl)triethoxysilane (APTES) with 4 ml of ethanol. The palladium ion solution is formed by dissolving 38 mg of palladium chloride (PdCl₂) in 1 ml of a hydrogen chloride solution with a concentration of 1 M, and then adding 5 ml of reverse osmosis water after the palladium chloride is completely dissolved. The reducing agent solution is sodium borohydride (NaBH₄) dissolved in an aqueous sodium hydroxide solution with a concentration of 0.025 M.

Next, the protective agent solution and the palladium ion solution are mixed and stirred for 30 minutes, and then the reducing agent solution is slowly added dropwise. When the color of the solution changes from transparent to black, it means that the palladium ions are reduced to palladium metal. After stirring at room temperature for 4 hours, the metal catalyst solution (1,250 ppm) can be obtained. Through transmission electron microscope image analysis of the metal catalyst solution, the particle size distribution of the metal catalyst is between 2 nm and 7 nm, and the average particle size of the metal catalyst is 4.19 nm.

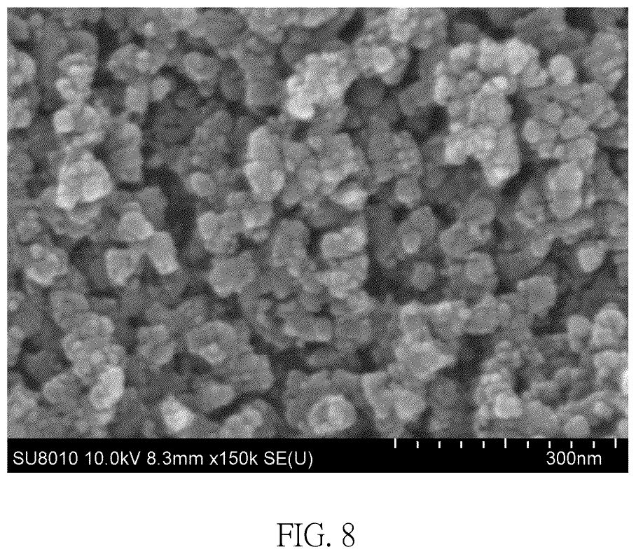

After diluting the concentration of the metal catalyst solution to 150 ppm, the glass substrate is immersed in the metal catalyst solution to allow the metal catalyst to adhere to the porous structure to complete the heterogeneous bonding layer of the present disclosure. At this time, the surface roughness (arithmetic mean height, Sa) of the heterogeneous bonding layer measured by an atomic force microscope is 21.18 nm. The scanning electron microscope image of the heterogeneous bonding layer is shown in FIG. 8. It can be found from FIG. 7 and FIG. 8 that the surface of the porous structure after adsorbing the metal catalyst (FIG. 8) is rougher than the surface before adsorbing the metal catalyst (FIG. 7).

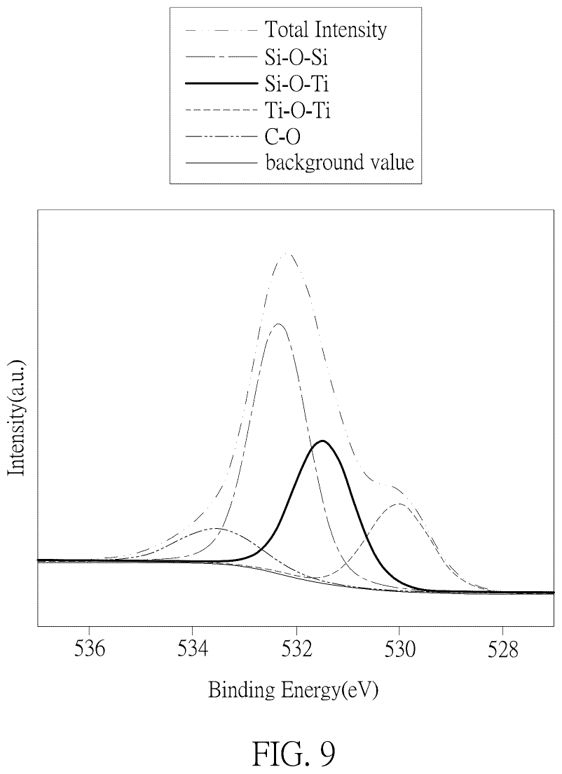

The heterogeneous bonding layer is also analyzed using X-ray photoelectron spectroscopy (XPS). The results are shown in FIG. 9 and Table 1.

TABLE 1

| Bonding type | Si—O—Si | Si—O—Ti | Ti—O—Ti | C—O |
|---|---|---|---|---|
| Atomic ratio | 45.5 | 27.4 | 17.7 | 9.4 |
| (%) | | | | |
| Binding | 532.3 | 534.5 | 530.0 | 533.5 |
| energy (eV) | | | | |

It can be seen from the results that the microstructure of the heterogeneous bonding layer does contain silicon-oxygen-titanium (Si—O—Ti) bonds, which means that the metal catalyst indeed adheres to the porous structure through the protective structure. In addition to Si—O—Ti bonds, the microstructure of the heterogeneous bonding layer further includes silicon-oxygen-silicon (Si—O—Si) bonds, titanium-oxygen-titanium (Ti—O—Ti) bonds, and carbon-oxygen (C—O) bonds. Moreover, the content of Si—O—Si bonds is greater than that of Si—O—Ti bonds, the content of Si—O—Ti bonds is greater than that of Ti—O—Ti bonds, and the content of Ti—O—Ti bonds is greater than that of C—O bonds.

Then, an electroless plating process is performed by immersing the glass substrate in a plating solution at 36° C. for 10 minutes, forming a metal layer with a thickness of 260 nm on the heterogeneous bonding layer, and performing an annealing process at 500° C. to obtain the metallized glass substrate of the present disclosure.

To confirm that the metallized glass substrate of the present disclosure has good peel strength, five samples are taken and a tensile testing machine (brand: Instron, model: 5543) is used to measure the peel strengths of the metallized glass substrates. The average results and standard deviation are listed in Table 2.

### Pore Size Test of Porous Structure

In order to compare the effects of porous structures with different pore sizes on the peel strength of metallized glass substrates, the metallized glass substrate of Test Example 1 is made using a manufacturing method similar to that of Embodiment 1. The difference is that porous structures with different average pore sizes are produced by regulating the particle size of commercial titanium dioxide slurry. The peel strength results of the metallized glass substrate of Test Example 1 are listed in Table 2.

TABLE 2

| | Embodiment 1 | Test Example 1 |
|---|---|---|
| Average pore size of porous | 30 | 18 |
| structure (nm) | | |
| Average peel strength (gf/cm) | 1392 | 1240 |
| Standard deviation of peel | 64 | 106 |
| strength (gf/cm) | | |

### Thickness Test of Porous Structure

In order to compare the effects of porous structures with different thicknesses on the peel strength of metallized glass substrates, the metallized glass substrates of Test Examples 2 to 5 are made using a manufacturing method similar to that of Embodiment 1. The difference is that porous structures of different thicknesses are produced by spin-coating precursor solutions and slurry mixtures of different thicknesses. The peel strength results of the metallized glass substrates of Test Examples 2 to 5 are listed in Table 3.

TABLE 3

| | | Test | Test | Test | Test |
|---|---|---|---|---|---|
| | Embodiment | Example | Example | Example | Example |
| | 1 | 2 | 3 | 4 | 5 |
| Thickness test | 330 | 300 | 240 | 200 | 140 |
| of porous | | | | | |
| structure (nm) | | | | | |
| Average peel | 1392 | 1490 | 1253 | 276 | 283 |
| strength (gf/cm) | | | | | |
| Standard deviation | 64 | 141 | 184 | 77 | 67 |
| of peel strength | | | | | |
| (gf/cm) | | | | | |

### Composition and Structure Test of Heterogeneous Bonding Layer

In order to compare the effects of different heterogeneous bonding layers on the peel strength of metallized glass substrates, the metallized glass substrates of Test Examples 6 to 9 are made using a manufacturing method similar to that of Embodiment 1. The difference lies in how the porous structure is formed and how the metal catalyst adheres. The peel strength results of the metallized glass substrates of Test Examples 6 to 9 are listed in Table 4.

TABLE 4

| | | Test | Test | Test | Test |
|---|---|---|---|---|---|
| | Embodiment | Example | Example | Example | Example |
| | 1 | 6 | 7 | 8 | 9 |
| Whether the | Yes | No | Yes | No | Yes |
| precursor solution is | | | | | |
| applied? | | | | | |
| Whether the slurry | Yes | No | Yes | Yes | No |
| mixture is applied? | | | | | |
| Whether it has | Yes | Yes | No | Yes | Yes |
| a protective structure? | | | | | |
| Average peel | 1392 | 72 | 1033 | 1172 | 186 |
| strength (gf/cm) | | | | | |
| Standard deviation | 64 | 31 | 265 | 198 | 26 |
| of peel strength | | | | | |
| (gf/cm) | | | | | |

### Reflow Test of Metallized Glass Substrate

Five metallized glass substrate samples are manufactured according to the method of Embodiment 1, and are reflowed at 250° C. The peel strengths of the metallized glass substrates are also measured according to the above method, and the results are listed in Table 5.

TABLE 5

| | Metallized glass substrates of Embodiment 1 | | | | |
|---|---|---|---|---|---|
| Reflow times | 1 | 2 | 3 | 4 | 5 |
| Peel strength (gf/cm) | 1173 | 1148 | 1017 | 1242 | 1238 |

It can be seen from the results in Table 5 that the metallized glass substrate of the present disclosure has good heat resistance. Even after repeated reflows, it can still maintain a peel strength of greater than 1000 gf/cm.

### Beneficial Effects of the Embodiment

In conclusion, in the metallized glass substrate and the method for manufacturing the same provided by the present disclosure, by virtue of “the microstructure of the heterogeneous bonding layer including Si—O—Ti bonds,” or “the material of the porous structure including titanium dioxide, and the thickness of the porous structure ranging from 210 nm to 350 nm,” the adhesion of the metal layer to the glass substrate can be improved.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A metallized glass substrate, comprising:
a glass substrate;
a heterogeneous bonding layer disposed on the glass substrate, and the heterogeneous bonding layer comprising:
a porous structure formed on the glass substrate, and a thickness of the porous structure ranging from 210 nm to 350 nm; and
a metal catalyst adhering to the porous structure;
wherein a microstructure of the heterogeneous bonding layer includes Si—O—Ti bonds; and
a metal layer disposed on the heterogeneous bonding layer.

2. The metallized glass substrate according to claim 1, wherein an atomic ratio of the Si—O—Ti bonds in the heterogeneous bonding layer ranges from 20% to 40%.

3. The metallized glass substrate according to claim 2, wherein the microstructure of the heterogeneous bonding layer includes the Si—O—Ti bond with the atomic ratio ranging from 25% to 35%, Si—O—Si bonds with an atomic ratio ranging from 40% to 50%, and Ti—O—Ti bonds with an atomic ratio ranging from 15% to 20%, and C—O bonds with an atomic ratio ranging from 5% to 15%.

4. The metallized glass substrate according to claim 1, wherein a surface roughness of the heterogeneous bonding layer ranges from 15 nm to 25 nm.

5. The metallized glass substrate according to claim 1, wherein an average pore size of the porous structure ranges from 10 nm to 40 nm.

6. The metallized glass substrate according to claim 1, a material of the porous structure includes titanium dioxide.

7. The metallized glass substrate according to claim 1, a surface density of the metal catalyst of the heterogeneous bonding layer ranges from 80 mg/cm² to 110 mg/cm².

8. The metallized glass substrate according to claim 1, wherein a particle size of the metal catalyst ranges from 2 nm to 10 nm.

9. The metallized glass substrate according to claim 1, wherein the metal catalyst adheres to the porous structure through a protective structure.

10. The metallized glass substrate according to claim 9, wherein the protective structure is formed of silane with a molecular weight ranging from 150 g/mol to 300 g/mol.

11. The metallized glass substrate according to claim 9, wherein the protective structure is (3-aminopropyl)triethoxysilane.

12. The metallized glass substrate according to claim 9, wherein the metal layer is partially embedded in the heterogeneous bonding layer.

13. A metallized glass substrate, comprising:
a glass substrate;
a heterogeneous bonding layer disposed on the glass substrate, and the heterogeneous bonding layer comprising:
a porous structure formed on the glass substrate, a material of the porous structure including titanium dioxide, and a thickness of the porous structure ranging from 210 nm to 350 nm; and
a metal catalyst adhering to the porous structure; and
a metal layer partially embedded in the heterogeneous bonding layer.

14. The metallized glass substrate according to claim 13, wherein a microstructure of the heterogeneous bonding layer includes Si—O—Ti bonds.

15. The metallized glass substrate according to claim 14, wherein an atomic ratio of the Si—O—Ti bonds in the heterogeneous bonding layer ranges from 20% to 40%.

16. The metallized glass substrate according to claim 15, wherein the microstructure of the heterogeneous bonding layer includes the Si—O—Ti bond with the atomic ratio ranging from 25% to 35%, Si—O—Si bonds with an atomic ratio ranging from 40% to 50%, and Ti—O—Ti bonds with an atomic ratio ranging from 15% to 20%, and C—O bonds with an atomic ratio ranging from 5% to 15%.

17. The metallized glass substrate according to claim 13, wherein a surface roughness of the heterogeneous bonding layer ranges from 15 nm to 25 nm.

18. The metallized glass substrate according to claim 13, wherein an average pore size of the porous structure ranges from 10 nm to 40 nm.

19. The metallized glass substrate according to claim 13, a surface density of the metal catalyst of the heterogeneous bonding layer ranges from 80 mg/cm² to 110 mg/cm².

20. The metallized glass substrate according to claim 13, wherein a particle size of the metal catalyst ranges from 2 nm to 10 nm.

21. The metallized glass substrate according to claim 13, wherein the metal catalyst adheres to the porous structure through a protective structure.

22. The metallized glass substrate according to claim 21, wherein the protective structure is formed of silane with a molecular weight ranging from 150 g/mol to 300 g/mol.

23. The metallized glass substrate according to claim 22, wherein the protective structure is (3-aminopropyl)triethoxysilane.

24. A method for manufacturing a metallized glass substrate, comprising:
forming a porous structure on a glass substrate, and a thickness of the porous structure ranging from 210 nm to 350 nm;
performing an activation process, so as to make a metal catalyst adhere to the porous structure to form a heterogeneous bonding layer, wherein a microstructure of the heterogeneous bonding layer includes Si—O—Ti bonds; and
performing a metallization process, so as to form a metal layer on the heterogeneous bonding layer.

25. The method according to claim 24, wherein, the process of forming the porous structure further includes:
applying a slurry mixture on the glass substrate, and the slurry mixture including a titanium ion-containing compound and a titanium-containing metal compound; and
performing a sintering process, so that the titanium ion-containing compound and the titanium-containing metal compound form the porous structure.

26. The method according to claim 24, wherein, the process of forming the porous structure further includes:
applying a precursor solution on the glass substrate, and the precursor solution including a titanium ion-containing compound;
applying a slurry mixture on the glass substrate, and the slurry mixture including a titanium-containing metal compound; and
performing a sintering process, so that the titanium ion-containing compound and the titanium-containing metal compound form the porous structure.

27. The method according to claim 25, wherein a weight ratio of the titanium ion-containing compound to the titanium-containing metal compound ranges from 6:1 to 8:1.

28. The method according to claim 26, wherein a weight ratio of the titanium ion-containing compound to the titanium-containing metal compound ranges from 6:1 to 8:1.

29. The method according to claim 25, wherein the titanium ion-containing compound includes titanium diisopropoxybisacetylacetonate.

30. The method according to claim 26, wherein the titanium ion-containing compound includes titanium diisopropoxybisacetylacetonate.

31. The method according to claim 25, wherein the titanium-containing metal compound includes titanium dioxide with a size ranging from 20 nm to 30 nm.

32. The method according to claim 26, wherein the titanium-containing metal compound includes titanium dioxide with a size ranging from 20 nm to 30 nm.

33. The method according to claim 24, wherein, the process of performing the activation process further includes:
preparing a metal catalyst solution, and the metal catalyst solution including the metal catalyst; and
immersing the porous structure in the metal catalyst solution, so that the metal catalyst adheres to the porous structure.

34. The method according to claim 33, wherein a content of the metal catalyst in the metal catalyst solution ranges from 140 ppm to 160 ppm.

35. The method according to claim 33, wherein the metal catalyst solution further includes a protective agent, so that the metal catalyst adheres to the porous structure through the protective agent, and the protective agent is silane with a molecular weight ranging from 150 g/mol to 300 g/mol.

36. The method according to claim 33, wherein the metal catalyst solution is formed by mixing a metal ion compound, a protective agent and an alcoholic solvent, and then adding a reducing agent, and the metal ion compound is reduced by the reducing agent to produce the metal catalyst.

37. The method according to claim 36, wherein the metal ion compound includes palladium chloride.
